(19) United States
(12) Patent Application Publication
(10) Pub. No.: US 2001/0010790 A1
(43) Pub. Date: Aug. 2, 2001

(54) Fasteners for decorative attachments to railings and gratings

(76) Inventors: Andrea Radaelli, Erba (IT); Giorgio Radaelli, Erba (IT); Patrizia Radaelli, Erba (IT); Alberto Radaelli, Erba (IT)

Correspondence Address: Abelman, Frayne & Schwab, 150 East 42nd Street, New York, NY, 10017-5612, US

(21) Appl. No.: 09/775,271

(22) Filed: Feb. 1, 2001

(30) Foreign Application Priority Data
Feb. 1, 2000 (IT) C02000A000004

(51) Int. Cl. F16B 21/00

(52) U.S. Cl. 411/338

(57) ABSTRACT

Fasteners for decorative attachments to railings, gratings and the like, such as, in particular, finials attached to the tops of standards of railings, and friezes attached to and/or wrapped-around the sides of standards or posts of railings and to the standards or posts that are the cross-members of gratings, according to the present invention, are constituted of annular bodies made from a material having elastic properties. The annular fastener bodies are fabricated as parts having either an integral, single-piece construction or as sectional, multi-piece parts. Each annular fastener body has an external surface and an internal surface, on which surfaces parallel protrusions are present, which are sequentially arranged in the form of saw-tooth indentations that are inclined, with the ones on the external surface being oriented in a first direction and the ones on the internal surface being oriented in the opposite direction, with respect to a longitudinal axis of symmetry through the annular fastener bodies. The fasteners are pressure-fitted between the peripheral surfaces of holes in the attachments, and the external surface of standards, with the saw-tooth indentations on the fastener body being in contact with the attachment or standard and are oriented in such a way with respect thereto as to facilitate pressure coupling and to prevent subsequent detachment.

### FIELD OF THE INVENTION

The present invention relates to fasteners for attaching decorative ornaments and attachments, such as finials and friezes, to railings, gratings and the like.

### BACKGROUND OF THE INVENTION

Fasteners for fixedly attaching decorative attachments to railings, gratings, and the like, particularly those railings and gratings made from metal, especially wrought iron, have previously been known in the art. The decorative attachments typically include top-mounted finials attached to the tops of standards, posts or shafts of railings and wrap-around friezes and other front-mounted decorative pieces that are attached to standards, posts or shafts of railings and to gratings. Top-mounted finials are sometimes also referred to as lance-studs because they often have the shape of a lance- or spearhead. Wrap-around decorative attachments, which sometimes have floral or geometric designs and patterns, that fit around standards, posts or shafts of railings and gratings, are sometimes also referred to as sleeve-studs because they are attached in a wrap-around or sleeve-like manner. Unless otherwise noted, the terms standard(s), post(s) and shaft(s), are used interchangeably herein to refer to the main metal bars and cross member elements of railings and gratings, and especially to the vertical members of railings. The standards, posts or shafts of railings and gratings to which the decorative ornaments are attached can have any shape, but usually have either circular, square, or other polygonal (e.g., hexagonal or octagonal) cross sectional areas in a direction transverse to their length or longitudinal axis. Such prior-art fasteners have generally been fabricated as annular elements made from metal that are interposed between the standards, posts or shafts of the railings and gratings and the decorative attachments themselves. These prior-art annular fastener elements engage and couple with corresponding cavities at an open, bottom end of the lance-studs and with a corresponding central annular channels or through-holes in the sleeve-studs that the fasteners are used to attach. The metal annular fastener elements are pressed into the corresponding cavities, after which the studs are positioned on the standards, posts, or shafts. The fasteners and the decorative attachments must then be welded in place by welding a permanent bead at a number of places around the periphery of the base of a lance-stud and around both ends of a sleeve-stud. Although such prior-art fasteners were an improvement over still earlier methods of attachment of decorative ornaments without the use of fasteners in a way that required even more extensive welding, usually a full welded seam line at each place of contact with the railing or grating post, which in the case of complex-shaped posts is a labor-intensive and time-consuming procedure, especially when numerous such attachments have to be made over a lengthy railing or large grating, even the prior-art fasteners had some drawbacks and/or limitations. Some of these drawbacks and limitations related to the use of the prior-art metal annular element fasteners, specifically are the need to form special seats on the lance- or sleeve-studs; that the fasteners themselves first be forcibly fit over the standards, posts, or shafts posts and the decorative stud attachments then be forcibly fit over the fasteners; and the continuing need to secure the fasteners and studs to the railing or grating posts with even relatively minimal welding operations. A still further drawback is that the installation of decorative stud attachments using the prior-art fasteners is that such operations must be carried out by specially trained personnel provided with special tools and equipment, such as welding machines, burring machines, and the like, and cannot readily be done by the amateur or occasional hobbyist or “do-it-yourselfers”.

### SUMMARY OF THE INVENTION

Accordingly, it is one object of the present invention to eliminate the above drawbacks and limitations of metal annular fasteners for decorative attachments to railings, gratings, and the like. The present invention, as is described hereinbelow and the scope of which is set forth by the set of claims appended hereto, solves and overcomes the problems of the prior art by providing fasteners for decorative attachments to railings, gratings, and the like, that have annular bodies made from a molded elastic material, such as plastic.

A further advantage of the present invention is that the plastic material used for the fasteners can be tinted with pigments so as to resemble the natural color of the metals used for the forming of the studs and the standards, posts, or shafts of railings, gratings and the like; the attachment of decorative ornaments such as lance-studs or finials and sleeve-studs or friezes to standards, posts, or shafts of railings and gratings using the fasteners of the present invention is direct and does not require any external preparation; the annular bodies of the fasteners of the present invention can be fabricated as a single-piece, monolithic element, or they can be made as multi-piece, modular elements, to allow their use under any coupling conditions, especially involving larger sizes and/or unusual geometries of attachments and/or standards, posts, or shafts.

The fasteners for attaching decorative ornaments to railings and gratings according to the present invention are fabricated as substantially annular bodies made from materials having elastic properties, either integral or sectional, on whose external and internal surfaces parallel protrusions are present, which are sequentially arranged in the form of annular saw-tooth indentations that are inclined, the external ones in one direction, the internal ones in the opposite direction with respect to a longitudinal axis of symmetry through the annular body of the fastener.

The advantages achieved by means of the present invention lie essentially in that the annular bodies, either integral or sectional, are already prefabricated and can be directly utilized on site on the details to be mutually coupled and fastened, without having to carry out any preliminary adaptation operation; the elasticity of the material from which the annular bodies are made allows an easy, rapid and economical application; the bodies are pressure-inserted in interposed position between the peripheral surfaces of the holes of the friezes or sleeve-studs and/or lance-studs and the like, and the external surfaces of the coupling standards, with the inclined indentations oriented in such a way as to facilitate the introduction, during the coupling of the parts, and to contrast and hinder the possible detachment attempts of the same; the coaxial configuration of the external perimeter and the central hole, provided with the coupling indentations, ensures the coaxial alignment of the friezes with the standards.

### BRIEF DESCRIPTION OF THE DRAWINGS

The invention will be described with more details hereunder, according to embodiments reported only by way of non-limiting example, with reference to the attached drawings, wherein:

FIG. 1 is a perspective view of a fastener for attaching a decorative ornament to a post of a railing or grating according to the present invention, wherein the fastener has a body made from an elastic material, with an external cylindrical shape and a central cylindrical through-hole.

FIG. 2 is a perspective view of a fastener for attaching a decorative ornament to a post of a railing or grating according to the present invention, wherein the fastener has a body made from an elastic material, with an external cylindrical shape and a central quadrangular through-hole.

FIG. 3 is a perspective view of an elastic semi-sector having an external cylindrical shape and a central cylindrical hole.

FIG. 4 is a perspective view of an elastic semi-sector having, an external cylindrical shape and a central quadrangular hole.

FIG. 5 shows a magnified partial cross-section of a coupling according to the invention, stressing the arrangement of the indentations and their retention manner with respect to the walls of the associated components.

FIG. 6 shows the partly sectioned view of a lance-stud with a dead hole, engaged on a standard by means of the adoption of fastening means according to the invention; and

FIG. 7 shows the partly sectioned view of a sleeve-stud with a through-hole, engaged on a standard by means of the adoption of fastening means according to the invention.

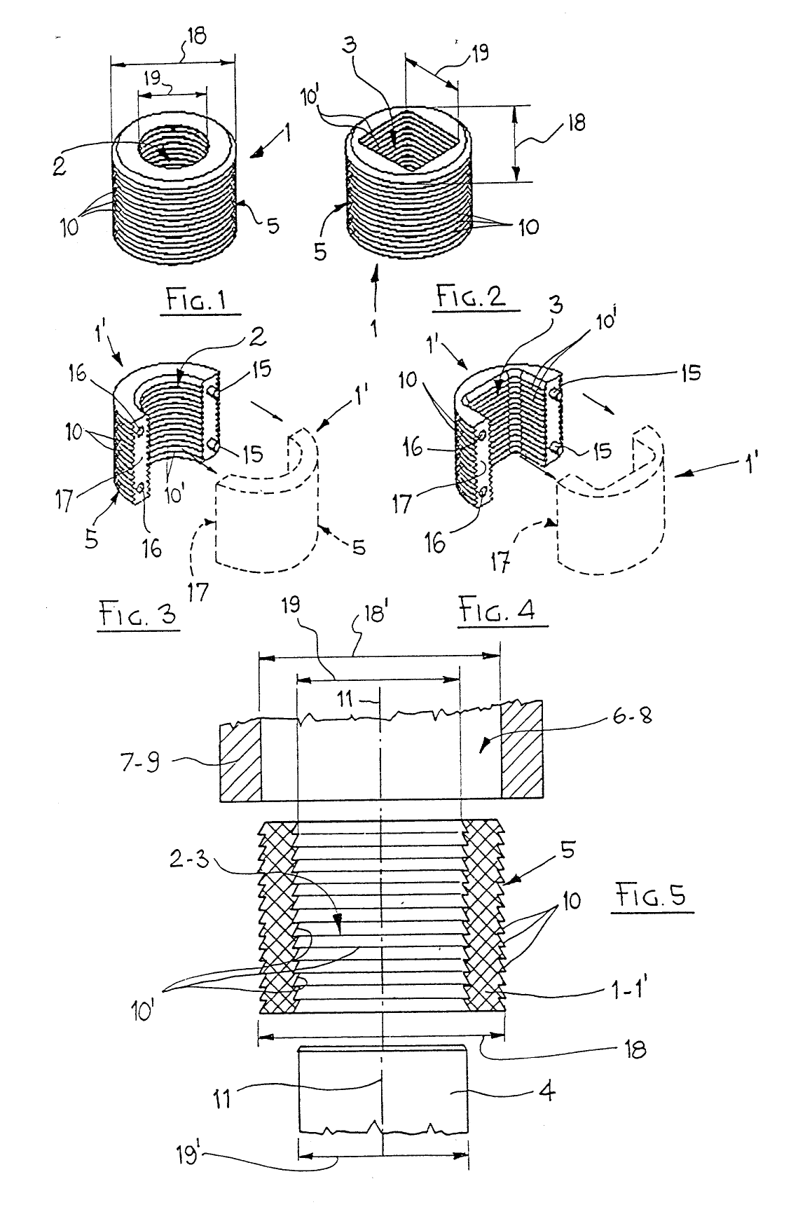

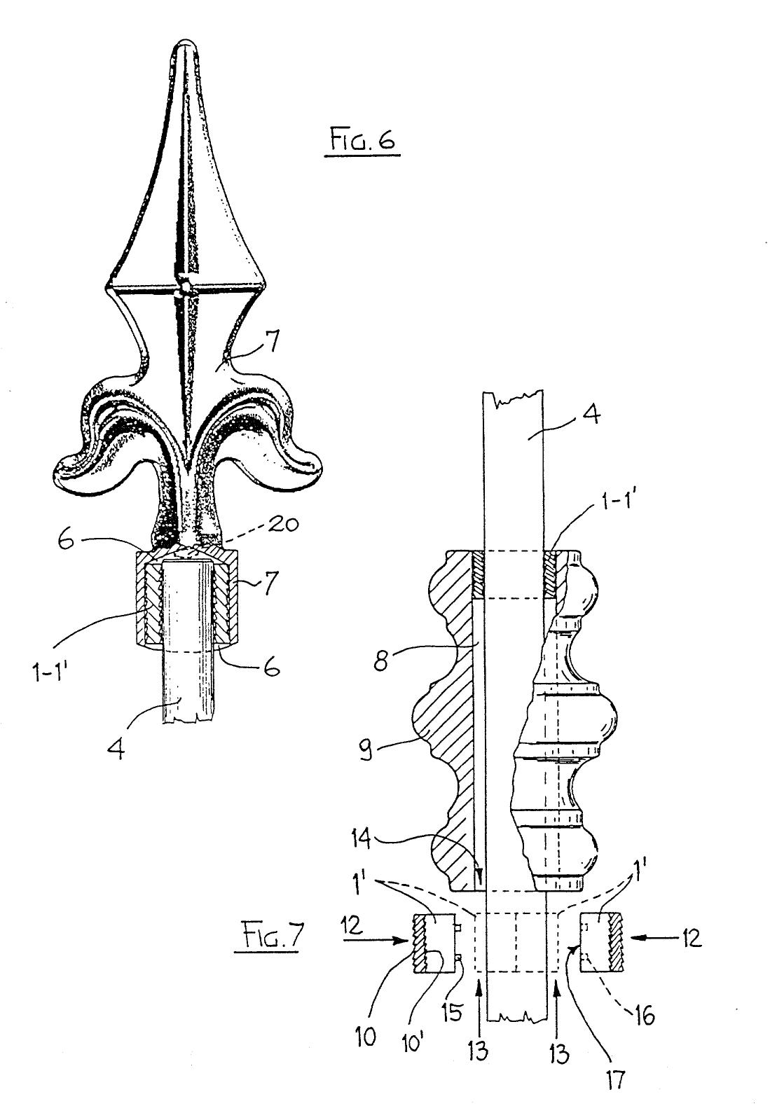

### DETAILED DESCRIPTION OF PREFERRED EMBODIMENTS OF THE INVENTION

Referring now generally to the accompanying drawing figures, fasteners for decorative ornaments, such as finials and friezes, for attachment to railings, gratings and the like, are substantially constituted of annular bodies made from a material having elastic properties, such as plastic. The fasteners are fabricated either as a single-piece, monolithic part (1) or as multi-piece, sectional part (1′). The annular bodies of the fasteners have a central annular channel or through-hole running through the fastener body parallel to a central longitudinal axis running through the fastener body. The central annular channel or through-hole can be made to any cross-sectional shape (as viewed in a plane perpendicular to the longitudinal axis), to enable the fastener to securely fit around any shape standard. Thus, the central annular channel or through-hole that runs through and forms the annular central channel in the fastener body may be circular (2), quadrangular (3) or other polygonally-shaped (e.g., such as hexagonal or octagonal), depending, on and corresponding to the cross section and shape of the standards (4) on which the fasteners are to be attached.

The external configuration (5) of the annular body of the fastener can also be of a variety of shapes, instead, substantially cylindrical, according to the corresponding usual configuration of the dead holes (6) obtained on the lance-studs (7) or to the corresponding end stud of standards (4), and the through-holes (8) obtained on the sleeve-studs (9) for intermediate applications on the standards.

However, it is not excluded the possibility that also the external surfaces of the elastic annular bodies (1, 1′) might have polygonal configurations, in case of coupling with corresponding polygonal dead-holes or through-holes obtained on the studs.

In any case, on the external (5) and internal (2, 3) surfaces of the annular bodies (1, 1′) parallel protrusions (10, 10′) are always present, which are sequentially arranged in the form of annular saw-tooth indentations that are inclined, the external ones (10) in a direction, the internal ones (10′) in the opposite direction with respect to the symmetry axis (11) of the annular bodies.

The annular elastic sectional bodies (1′) are so constituted as to be radially modular with each other to form a complete annular body corresponding to the integral ones (1) and to realize identical couplings between the studs (7, 9) and the standards (4). Their use is therefore corresponds to one of the integral bodies. Forming the annular bodies of the fasteners in several parts additionally has the advantage of being easier to mold, without the need for larger, more complex molds with undercuts or mobile carriages, and being adoptable also in case of difficulty of axial insertion in the standards. In this case, the elastic annular bodies may be composed around the standards (4), approaching and radially coupling sectors (1′) according to the arrows (12) of FIG. 7, and subsequent forced introduction, according, to the direction of arrows (13) in interspace (14) constituted by the coupling of a standard (4) with any type of decorative stud (7, 9). The radial composition of the sectors is facilitated and ensured by means of the coupling of integral pins (15) with corresponding seats (16), present on the complementary faces (17) of the sectors.

Preferably, the annular bodies (1′) are realized as two half-sectors diametrically modular—however, the possibility of a different subdivision is not excluded. Besides the coupling between pin (15) and seats (16), faces (17) of the sectors can also be secured by glue.

The annular bodies (1, 1′) are realized from a material having elastic properties, such as for instance plastics in general, and the like. The material can be pigmented according to the natural color of the metals used to form the studs and the standards for railings and gratings; the elasticity of the material adopted has the function of facilitating the forced pressure-insertion of bodies (1, 1′) in the respective seats (6, 8) and of creating the resistance necessary to prevent the possible subsequent extraction attempts.

For this reason, the maximum top level of the parallel saw-tooth protrusions (10) of the external configuration (5) is complementary to the coupling level (18′) with the dead holes (6) or through-holes (8) of studs (7, 9), or the like, and the minimum top level of the saw-tooth parallel protrusions (10′) of the central through-holes (2, 3) is complementary to the coupling level (19′) with standards (4), unless an interference is provided, depending on the elasticity of the materials, which the annular bodies (1, F) are made from.

The annular bodies (1 and/or 1′) are pressure-fitted in the holes (6 and/or 8) of studs (7 and/or 9), through the engagement of their external surfaces (5) orienting towards the holes the inclined part of the annular indentations (10) so as to create a stress raiser for their introduction and to facilitate their elastic peripheral deformation. Once the introduction has been completed, the annular indentations tend to elastically recovering, their original conformation, expanding as much as possible against the walls of the holes and engaging with the same, while the respective peripheral ends are so oriented as to contrast and hinder any subsequent extraction attempt.

Afterwards, and in the same manner, the standards (4) are pressure-fitted into the central holes (2 and/or 3) of the annular bodies (1 and/or 1′) engaged in holes (6 and/or 8) of studs (7 and/or 9). Also this introduction is facilitated by the orientation of the internal annular indentations (10′) contrary to the one of the external annular indentations (10). In this way also the annular indentations (10′) create a stress raiser for the introduction of the standards, deforming, elastically. At the end, the indentations recover elastically their original conformation, expanding as much as possible against the walls of the holes and engaging with the same, while the respective peripheral ends are also so oriented as to contrast and hinder any subsequent extraction attempts.

The pressure-fitted couplings, carried out in the described manner, perfectly fixed and coaxially aligned, are of easy and rapid realization, require elementary tools, such as middle weight hammers or uphand hammers, and may be realized with excellent results also by non specialized personnel or by “do-it-yourselfers”.

Optional additional methods for securing lance-studs or end studs with dead-holes (6) can be obtained by placing capsules (20) containing glue, such as for instance cyanoacrylic glue or the like, on the tops of standards (4). At the end of the introduction in holes (2, 3) of the elastic bodies (1, 1′), the standards (4) puncture or rupture the glue-containing capsules (20), causing the glue to spread over the standards (4), studs (7), elastic bodies (1, 1′), with the glue infiltrating into all indentations (10, 10), in order to achieve a total adhesion between the parts. Alternatively, first applying glue on the surfaces of the elastic bodies (1, 1′) of the fasteners, which are then inserted in holes (8) of sleeve-studs (9), produces the same adhesion between those parts.

While the present invention has been described and illustrated according to the foregoing embodiments, which are non limiting examples of embodiments of the present invention, further embodiments thereof, which are within the scope of the invention as set forth in the following appended set of claims, will be obvious to those skilled in the art.

What is claimed is:

1. A fastener for securing a decorative attachment to a post of a railing or grating, the fastener comprising an annular body made from a material having elastic properties, the annular body having an external surface and an internal surface, with a plurality of parallel protrusions on each of the external and internal surfaces, such that the plurality of parallel protrusions are perpendicular to a central longitudinal axis through the annular body and are sequentially arranged to form a pattern of inclined saw-tooth indentations, and further such that the saw-tooth indentations on the external surface are oriented in a first direction and the saw-tooth indentations on the internal surface are oriented in a second direction that is opposite to the direction of the saw-tooth indentations on the external surface.

2. The fastener according to claim 1, wherein the annular body is formed from a single integral piece.

3. The fastener according to claim 1, wherein the annular body is formed from a plurality of adjoining pieces.

4. The fastener according to claim 3, wherein there are two pieces.

5. The fastener according to claim 3, wherein the pieces are provided with mutually engaging connection means to enable adjoining pieces to be connected to one another.

6. The fastener according to claim 5, wherein the connection means are pins and cooperating seats.

7. The fastener according to claim 6, wherein each piece has a plurality of at least one of pins and seats.

8. The fastener according to claim 1, wherein the annular body has a cylindrical annulus with a cross-sectional area in a plane orthogonal to its longitudinal central axis that has a shape selected from the group consisting of circular and polygonal.

9. The fastener according to claim 8, wherein the annulus of the annular body has a circular cross-sectional area.

10. The fastener according to claim 8, wherein the annulus of the annular body has a polygonal cross-sectional area.

11. The fastener according to claim 10, wherein the polygonal shaped cross-sectional area of the annulus is quadrangular.

12. The fastener according to claim 1, wherein the annular body has an external configuration that corresponds to and cooperates with the configuration of at least one of dead-holes on lance-studs and end-studs that are fitted onto the ends of standards; and through-holes on sleeve-studs that are fitted over standards.

13. The fastener according to claim 12, wherein the annular body has an external configuration selected from the group consisting of: a circular cylinder; and a polygonal cylinder.

14. The fastener according to claim 13, wherein the annular body has the external configuration of a circular cylinder.

15. The fastener according to claim 13, wherein the annular body has the external configuration of a polygonal cylinder.

16. The fastener according to claim 1, wherein the annular body has an external configuration that corresponds to and cooperates with the configuration of at least one of dead-holes on lance-studs and end-studs that are fitted onto the ends of standards; and through-holes on sleeve-studs that are fitted over standards; and the annular body has a cylindrical annulus with a cross-sectional area in a plane orthogonal to its longitudinal central axis that has a shape selected from the group consisting of circular and polygonal.

17. The fastener according to claim 16, wherein the plurality of parallel protrusions perpendicular to a central longitudinal axis through the annular body that are sequentially arranged to form a pattern of inclined saw-tooth indentations on the external surface of the annular body have a height such that they outwardly extend a distance from the cylindrical external configuration of the of the annular body, and such that the cylinder of the annular body and the saw-tooth indentations thereon together have a maximum combined outer diameter that is not greater than a corresponding inner diameter of lance studs and end studs with which at least one end of the cylinder of the annular body insertingly cooperates or an inner diameter of a sleeve-stud through which the annular body insertingly cooperates; and wherein the plurality of parallel protrusions perpendicular to a central longitudinal axis through the annular body that are sequentially arranged to form a pattern of inclined saw-tooth indentations on the internal surface of the annular body have a height such that they inwardly extend a distance from an inner wall of the annular internal cylindrical configuration of the of the annular body, and such that the internal cylinder of the annular body with the saw-tooth indentations thereon together have a minimum inner diameter that is not less than a corresponding outer diameter of a standard over which the annular internal cylindrical configuration of the annular body with the saw-tooth indentations on the internal surface thereof slidingly cooperates, except that where there is provided at least one of an external adapter to fit over the external configuration of the annular body, and an internal adapter to fit inside the annulus of the annular body, the maximum outer diameter of the annular body and saw-tooth indentations thereon can be less than the inner diameter of a lance-stud or end stud into which the annular body is insertable, or the inner diameter of a sleeve-stud over which the annular body is slidable; and the minimum inner diameter of the annulus of the annular body with the saw-tooth indentation therein can be greater than the outer diameter of a standard over which the annular body is slidable, such that a width of a differential diameter between either of the outer diameter of annular body and elements fitting thereover, and the inner diameter of the annular body and elements fitting therein or therethrough is provided for by the external adapter or the internal adapter, respectively.

18. The fastener according to claim 1, wherein the saw-tooth indentations on the external surface are oriented in a direction such that when a lance stud or end stud is fitted over an end of the annular member, an inclined part of the saw-tooth indentations faces in the direction of insertion and are elastically stress-deformed in that direction and press outwardly against the stud in a pressure-fit coupling, such that a resistive force opposite to a direction of removal of the stud is created when the stud is moved in a direction of removal thereof, so as to urge the stud to be retained on the annular body; and wherein the saw-tooth indentations on the internal surface are oriented in a direction such that when a standard is fitted in or through the annulus of the annular member, an inclined part of the saw-tooth indentations faces opposite to the direction of insertion of the post, and are elastically stress-deformed in that direction and press outwardly against the post in a pressure-fit coupling, such that a resistive force opposite to a direction of removal of the post is created when the post is moved in a direction of removal thereof, so as to urge the post to be retained in the annulus of the annular body.

19. The fastener according to claim 1, wherein the elastic material is a plastic.

20. The fastener according to claim 19, wherein the plastic contains a pigment such that the plastic resembles a metal.
